(19) United States
(12) Patent Application Publication
(10) Pub. No.: US 2017/0068760 A1
(43) Pub. Date: Mar. 9, 2017

(54) METHOD FOR ESTIMATING USE STATE OF POWER OF ELECTRIC DEVICES

(71) Applicant: Panasonic Intellectual Property Corporation of America, Torrance, CA (US)

(72) Inventors: YUKIE SHODA, Osaka (JP); IKU OHAMA, Osaka (JP); RYOTA FUJIMURA, Kanagawa (JP); HIDEO UMETANI, Osaka (JP)

(21) Appl. No.: 15/251,794

(22) Filed: Aug. 30, 2016

(30) Foreign Application Priority Data
Sep. 4, 2015 (JP) 2015-175191

(51) Int. Cl. G06F 17/50; G06F 17/18

(52) U.S. Cl. CPC G06F 17/5009; G06F 17/18

(57) ABSTRACT

A method includes estimating a model parameter in a case where operating states of plural electric devices are modeled by a probability model by using a total value of power consumption of the plural electric devices connected with a panel board. In the estimating, the model parameter in which likelihood calculated by a likelihood function becomes a maximum is estimated based on characteristics of power data that may be predetermined as prior knowledge from an operation tendency of each of the plural electric devices, the probability model is a factorial hidden Markov model (FHMM), and the likelihood is a value that indicates certainty of a pattern of a total value of the power consumption, which is modeled by the FHMM, of the plural electric devices with respect to a total value of the power consumption that is actually measured.

### BACKGROUND

1. Technical Field

The present disclosure relates to a power use state estimation method, a power use state estimation apparatus, and a non-transitory recording medium having a computer program stored thereon.

2. Description of the Related Art

In recent years, power consumption may be measured by a panel board installed in a house or the like, and services for facilitating energy saving by displaying the power consumption status in the house has been performed.

However, measurement of power consumption of individual electric devices connected with the panel board has not yet been realized. The power consumption of the individual devices may be measured by mounting smart taps or the like on the individual electric devices. However, mounting the smart taps is not realistic in view of cost.

Differently, a technique has been suggested in which the power consumption or the like of electric devices in a house is estimated from the information of the power consumption measured by the panel board without mounting the smart taps (for example, Japanese Patent No. 5668204). Japanese Patent No. 5668204 discloses a technique in which the power consumption or the like of electric devices may be estimated by using a factorial hidden Markov model (factorial HMM; hereinafter referred to as FHMM) and without using identified learning data about each electric device. The above known learning data are pattern data of characteristic power use amounts in a case where the electric devices are used.

### SUMMARY

However, the estimated use states of the electric devices may not be realistic use states of the electric devices in the above related art. That is, the above related art has a problem that the accuracy of learning results of the FHMM may be low.

One non-limiting and exemplary embodiment provides a power use state estimation method, power use state estimation apparatus, and a non-transitory recording medium having a computer program stored thereon that enable accuracy of learning results of an FHMM to be improved.

In one general aspect, the techniques disclosed here feature a power use state estimation method including: acquiring a total value of power consumption of plural electric devices that are connected with a panel board; and estimating a parameter for estimating a model parameter in a case where operating states of the plural electric devices are modeled by a probability model by using the total value, in which in the estimating a parameter, a model parameter in which likelihood that is calculated by a likelihood function becomes a maximum is estimated based on characteristics of power data that are capable of being predetermined as prior knowledge from an operation tendency of each of the plural electric devices, the probability model is a factorial hidden Markov model (factorial HMM), and the likelihood is a value that indicates certainty of a pattern of a total value of the power consumption which is modeled by the factorial HMM with respect to a total value of the power consumption that is actually measured.

It should be noted that general or specific embodiments may be implemented as a system, a method, an integrated circuit, a computer program, or a computer-readable recording medium such as a CD-ROM, or any selective combination thereof.

A power use state estimation method and so forth of the present disclosure may improve accuracy of learning results of an FHMM.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram that illustrates a configuration of a system in a first embodiment;

FIG. 2A is a block diagram that illustrates one example of the configuration of a power use state estimation apparatus in the first embodiment;

FIG. 2B is a block diagram that illustrates one example of a specific configuration of a parameter estimation unit;

FIG. 3A is a flowchart that illustrates a model parameter estimation process of an FHMM in the power use state estimation apparatus in the first embodiment;

FIG. 3B is a flowchart for explaining details of an M step process in S14;

FIG. 4A is a diagram for explaining effects of the first embodiment;

FIG. 4B is a diagram for explaining effects of the first embodiment;

FIG. 4C is a diagram for explaining effects of the first embodiment;

FIG. 5 is a block diagram that illustrates one example of a configuration of a parameter estimation unit according to a modification example of the first embodiment;

FIG. 6A is a block diagram that illustrates one example of a configuration of a power use state estimation apparatus in a second embodiment;

FIG. 6B is a block diagram that illustrates one example of a specific configuration of a parameter estimation unit in FIG. 6A;

FIG. 7 is a flowchart that illustrates a model parameter estimation process of the FHMM in the power use state estimation apparatus in the second embodiment;

FIG. 8A is a block diagram that illustrates one example of a configuration of a power use state estimation apparatus in a third embodiment;

FIG. 8B is a block diagram that illustrates one example of a specific configuration of a parameter estimation unit in FIG. 8A;

FIG. 9 is a block diagram that illustrates another example of the configuration of the power use state estimation apparatus in the third embodiment;

FIG. 10 is a flowchart that illustrates a model parameter estimation process of the FHMM in the power use state estimation apparatus in the third embodiment;

FIG. 11 is a flowchart that illustrates a process of the Viterbi algorithm;

FIG. 12A is a diagram for explaining one example of a process of S34;

FIG. 12B is a diagram for explaining one example of the process of S34;

FIG. 13 is a diagram for explaining an electric device estimation apparatus of Japanese Patent No. 5668204;

FIG. 14 is a block diagram for explaining a function configuration of the electric device estimation apparatus of Japanese Patent No. 5668204;

FIG. 15A is a diagram that depicts an HMM by a graphical model;

FIG. 15B is a diagram that depicts the FHMM by a graphical model;

FIG. 16 is a diagram for explaining a relationship between the FHMM and electric devices;

FIG. 17 is a flowchart that illustrates a model parameter estimation process of the FHMM in the electric device estimation apparatus of Japanese Patent No. 5668204; and

FIG. 18 is a flowchart for explaining details of S93.

### DETAILED DESCRIPTION

### Underlying Knowledge Forming Basis of One Aspect of the Present Disclosure

The present inventor(s) found that Japanese Patent No. 5668204 described in the section of “BACKGROUND” has the following problems.

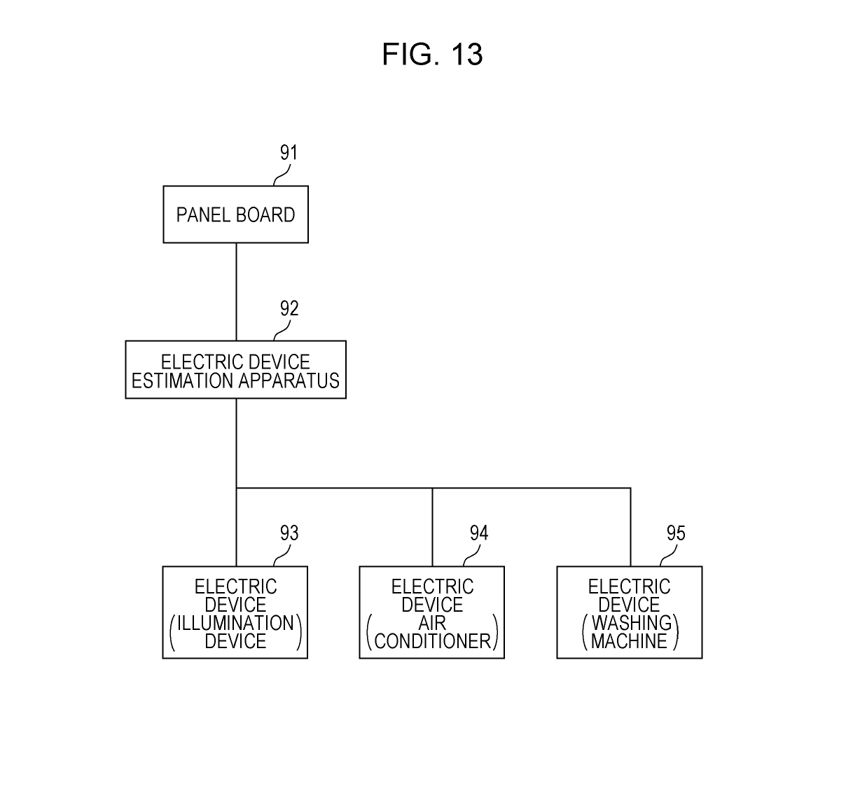

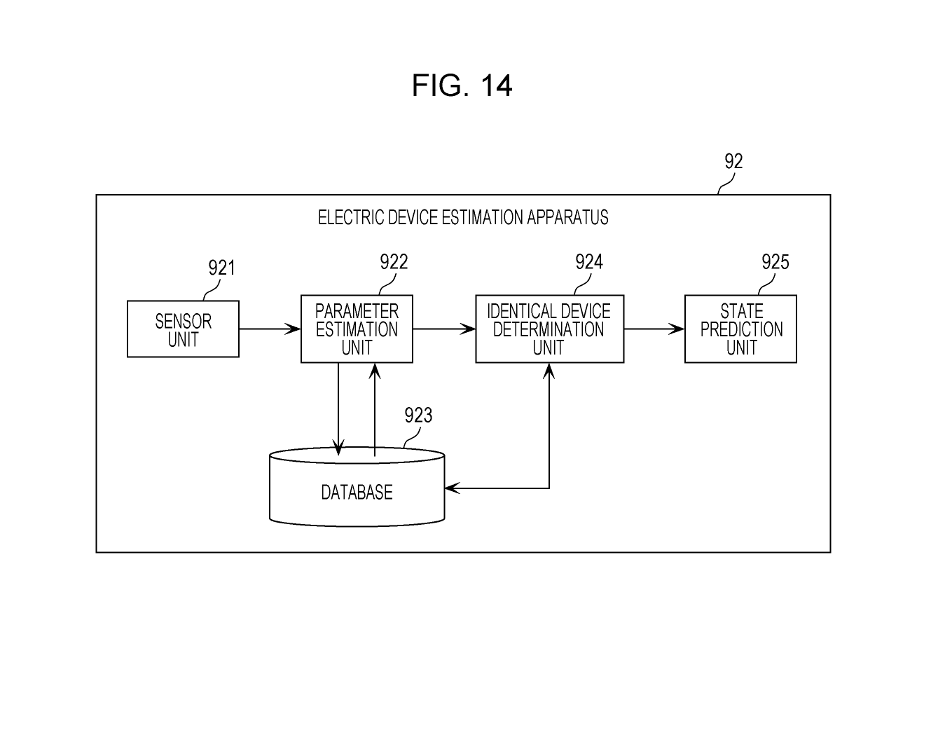

FIG. 13 is a diagram for explaining an electric device estimation apparatus of Japanese Patent No. 5668204. FIG. 14 is a block diagram for explaining a function configuration of the electric device estimation apparatus illustrated in FIG. 13.

Electricity supplied from a power company to a residence or the like first enters a panel board 91 and is supplied from the panel board 91 to an electric device 93 to an electric device 95 that are installed in respective places in the residence as illustrated in FIG. 13. In the example illustrated in FIG. 13, the electric device 93 is an illumination device such as a light bulb, the electric device 94 is an air conditioner, and the electric device 95 is a washing machine, for example.

An electric device estimation apparatus 92 acquires the total of the power consumption of plural electric devices (the electric device 93 to electric device 95) installed in the respective places in the residence, which is measured by the panel board 91. The acquired power consumption corresponds to the total value of consumed currents derived from the combinations of use states of the electric device 93 to electric device 95 that are installed in the respective places in the residence. The electric device estimation apparatus 92 estimates the operating states of the electric device 93 to electric device 95 from the acquired total value of the consumed currents. Further, the electric device estimation apparatus 92 displays the present operating state of each of the electric device 93 to electric device 95 and predicts the future operating states of the electric device 93 to electric device 95 at the time after a prescribed time elapses from the present time, based on estimation results.

Here, a description will be made about a method of estimating the power consumption or the like of each of plural electric devices by using an FHMM. A technique that estimates the states of electric devices which are connected to a panel board from the information of currents measured by the panel board is referred to as non-intrusive load monitoring (hereinafter referred to as NILM) and has been researched from the 1980s. Using the NILM provides a large advantage of enabling recognition of the states of all the electric devices connected with the panel board based on the measurement results at the panel board, that is, the measurement results at one place without using a measurement device such as a smart tap for each of the individual electric devices (loads).

The electric device estimation apparatus 92 estimates the operating state of each of the electric device 93 to electric device 95 by using the FHMM as an analysis measure of the NILM. In other words, the electric device estimation apparatus 92 calculates (estimates) a model parameter that is modeled by the FHMM in order to estimate the operating state of each of the electric device 93 to electric device 95 and estimates the operating states by using the estimated model parameter. [FHMM]

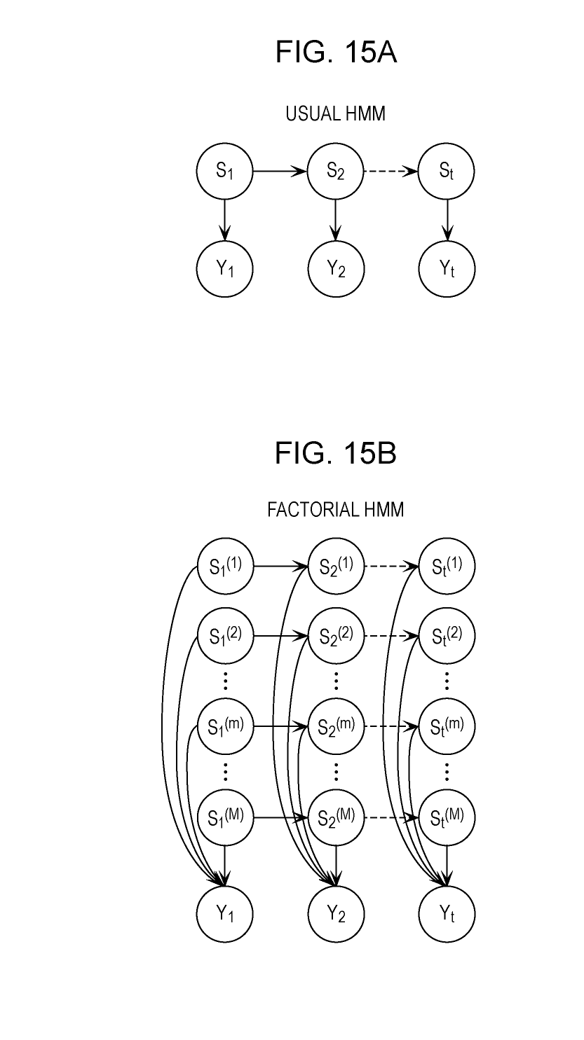

The FHMM will briefly be described below. FIG. 15A is a diagram that depicts a hidden Markov model (HMM) by a graphical model, and FIG. 15B is a diagram that depicts the FHMM by a graphical model.

As illustrated in FIG. 15A, in the HMM, one state variable Sₜ corresponds to observation data Yₜ at a time t. Meanwhile, as illustrated in FIG. 15B, in the FHMM, plural state variables Sₜ (M variables in FIG. 15B) are present as expressed by Sₜ⁽¹⁾, Sₜ⁽²⁾, Sₜ⁽³⁾, . . . , Sₜ^{(m)}, . . . , Sₜ^{(M)}. Then, one set of observation data Yₜ is generated from the plural state variables Sₜ⁽¹⁾ to Sₜ^{(M)}.

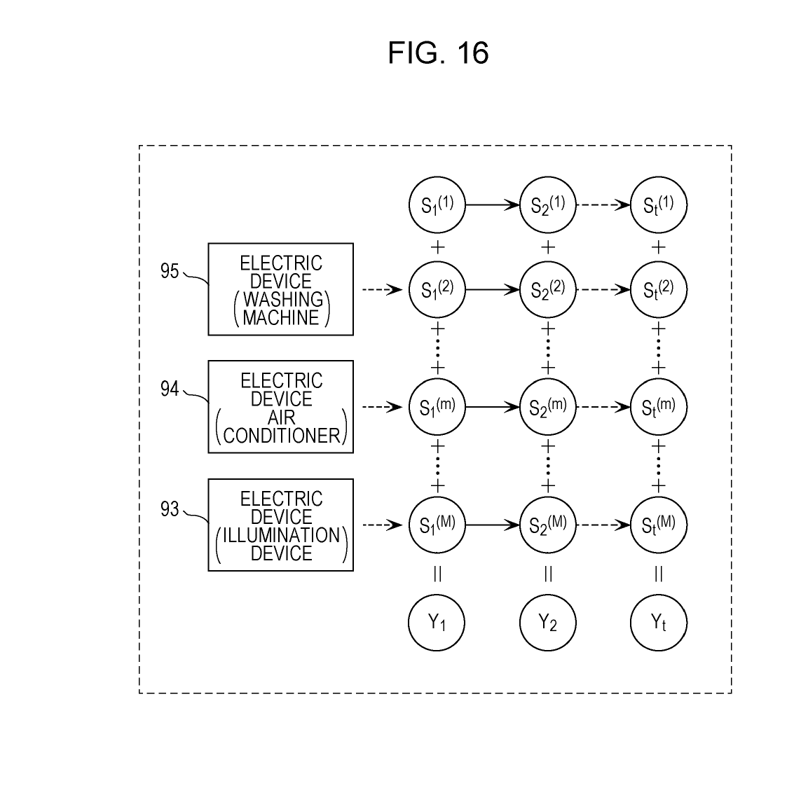

FIG. 16 is a diagram for explaining the relationship between the FHMM and the electric device 93 to electric device 95 illustrated in FIG. 13. FIG. 16 illustrates the graphical model of the FHMM illustrated in FIG. 15B, which is associated with the electric device 93 to electric device 95 illustrated in FIG. 13. That is, each of the M state variables S⁽¹⁾ to S^{(M)} of the FHMM corresponds to the electric device 93 to electric device 95. Further, the state values of the state variable S^{(m)} correspond to the states (for example, two states of ON and OFF) of the electric device 93 to electric device 95.

More specifically, state values S₁⁽²⁾ to Sₜ⁽²⁾ in accordance with the elapsed time, of the second state variable S⁽²⁾ among the M state variables S⁽¹⁾ to S^{(M)} correspond to the states of the electric device 95 (washing machine). Further, state values S₁^{(m)} to Sₜ^{(m)} in accordance with the elapsed time, of the mth state variable S^{(m)} correspond to the states of the electric device 94 (air conditioner). Similarly, state values S₁^{(M)} to Sₜ^{(M)} in accordance with the elapsed time, of the Mth state variable S^{(M)} correspond to the states of the electric device 93 (illumination device). Further, the total values of the power consumption derived from the combinations of the use states of the plural electric devices (the electric device 93 to electric device 95) that are installed in the respective places in the residence are obtained as observation data Y₁ to Yₜ.

In the description made below, the mth state variable S^{(m)} among the M state variables S⁽¹⁾ to S^{(M)} will be described as the mth factor or factor m. Details of the FHMM are disclosed in Zoubin Ghahramani and Michael I. Jordan, “Factorial Hidden Markov Models”, Machine Learning Volume 29, Issue 2-3, November/December 1997. Thus, a detailed description thereof will not be made here.

A description will next be made about an estimation method (calculation method) of a model parameter of the FHMM.

Given that hidden states for observation data {Y₁, Y₂, Y₃, . . . , Yₜ, . . . , Y_{T}} are {S₁, S₂, S₃, . . . , Sₜ, . . . , S_{T}}, the joint probability of the hidden states Sₜ and the observation data Yₜ is given by the following equation (1).

$$P ( \{ {S}_{t} , {V}_{t} \} ) = P ( {S}_{1} ) P ( {Y}_{1} \vert {S}_{1} ) {\prod }_{t = 2}^{T} P ( {Y}_{t} \vert {S}_{t - 1} ) P ( {Y}_{t} \vert {S}_{t} ) \qquad ( Equation 1 )$$

Here, in the equation (1), P(S₁) represents an initial probability, P(Sₜ|Sₜ₋₁) represents a state transition probability, and P(Yₜ|Sₜ) represents an observation probability. Those may be calculated by the following equation (2), equation (3), and equation (4).

$$\begin{matrix}P ( {S}_{1} ) = {\prod }_{m = 1}^{M} P ( {S}_{1}^{( m )} ) = {\prod }_{m = 1}^{M} {π}^{( m )} & ( Equation 2 ) \\ P ( {S}_{t} \vert {S}_{t - 1} ) = {\prod }_{m = 1}^{M} P ( {S}_{t}^{( m )} {S}_{t - 1}^{( m )} ) = {\prod }_{m = 1}^{M} {A}^{( m )} & ( Equation 3 ) \\ P ( {Y}_{t} \vert {S}_{t} ) = Nomal ( {Y}_{t} ; {μ}_{t} , C ) & ( Equation 4 )\end{matrix}$$

### However,

μₜ=Σₘ₌₁^{M}W^{(m)}Sₜ^{(m)}

A description will be made below about estimation of a model parameter in the FHMM on an assumption that one factor corresponds to one electric device. In a case where one factor corresponds to one electric device, the electric device that corresponds to the factor m will also be referred to as mth electric device.

The term Sₜ^{(m)} in the equation (2) to equation (4) represents the states (ON, OFF, high-mode operation, low-mode operation, and so forth) of the mth electric device at the time t. Given that the number of states of the mth electric device is K, Sₜ^{(m)} is configured with a K-dimensional column vector (a vector of K rows and one column). In a case where the states of the mth electric device are ON, OFF, high-mode operation, and low-mode operation, for example, the number of states is four.

The initial probability P(S₁) may be calculated by the multiplication of M π^{(m)} as expressed by the equation (2). In the equation (2), π^{(m)} represents an initial state probability of the mth electric device and is a K-dimensional column vector.

As expressed by the equation (3), the state transition probability P(Sₜ|Sₜ₋₁) may be calculated by the multiplication of M A^{(m)}. In the equation (3), A^{(m)} represents the state transition probability of the mth electric device and is configured with a square matrix of K rows and K columns (K×K). The term A^{(m)} corresponds to easiness of switching from ON to OFF or the like, for example.

As expressed by the equation (4), the observation probability P(Yₜ|Sₜ) may be calculated by a multivariate normal distribution of an observation average μₜ and a covariance matrix C.

As expressed by the equation (4), the term W^{(m)} is a parameter of the observation probability P(Yₜ|Sₜ) and corresponds to a pattern of a current waveform of the current consumed by the mth electric device. Because the pattern of the current waveform is different with respect to each state of the electric device, W^{(m)} becomes a matrix of D rows and K columns (D×K) in which the number of dimensions D in the observation data is the number of rows and the number of states K in the observation data is the number of columns. The term μₜ represents the observation average (observation probability average or probability average) at the time t and is the sum of M column elements that correspond to the state Sₜ^{(m)} of the matrix W^{(m)}. In other words, the observation average μₜ corresponds to the sum of the current values in accordance with the states of the all the electric devices. Accordingly, in a case where the observation average μₜ is close to the observation data Yₜ at the time t, the model parameter has likelihood. The covariance matrix C corresponds to the intensity of noise on the current pattern and is common to all times and all the electric devices.

A description will next be made about a function configuration of the electric device estimation apparatus 92 with reference to FIG. 14. As illustrated in FIG. 14, the electric device estimation apparatus 92 includes a sensor unit 921, a parameter estimation unit 922, a database 923, an identical device determination unit 924, and a state prediction unit 925.

The sensor unit 921 measures (acquires) the total value of the consumed currents derived from the combinations of the use states of the plural electric devices (the electric device 93 to electric device 95) that are installed in the respective places in the residence as the observation data Yₜ (t=1, 2, . . . , T) and supplies the total value to the parameter estimation unit 922.

The parameter estimation unit 922 calculates a model parameter, in which the operating state of each of the electric device 93 to electric device 95 is modeled by the FHMM, based on the observation data {Y₁, Y₂, Y₃, . . . , Yₜ, . . . , Y_{T}} as time-series data of the total value of the consumed currents of the electric device 93 to electric device 95. The model parameter obtained by a learning process of the FHMM is saved in the database 923.

The identical device determination unit 924 detects plural factors in which the identical electric device 93 to electric device 95 from M factors are modeled and causes the database 923 to store detection results. In other words, the identical device determination unit 924 determines whether a first factor m₁ and a second factor m₂ (m₁≠m₂) among the M factors represent the identical electric device 93 to electric device 95 and registers a determination result in the database 923.

Here, the FHMM itself is a general-purpose modeling scheme of time-series data and is applicable to various problems other than the NILM. Thus, there are problems that a conventional estimation scheme that uses the FHMM may not suitably applied to the NILM. One of the problems is that there is a case where one of the electric device 93 to electric device 95 is modeled by plural factors. Thus, the identical device determination unit 924 detects that the plural factors correspond to an identical electric device in a case where one electric device is represented by plural factors.

The state prediction unit 925 uses the model parameter stored in the database 923 to predict the future states of the factors m (the electric device 93 to electric device 95) at a time after a prescribed time elapses from the present time. Needless to say, the FHMM is a probability model based on the HMM and may thus predict a state probability at a future time by probability.

As described above, specifically, an estimation of a model parameter of the FHMM by the parameter estimation unit 922 corresponds to calculation of the initial state probability π^{(m)} of the mth electric device, the state transition probability A^{(m)}, the parameter W^{(m)} of the observation probability (average observation probability), and the covariance matrix C.

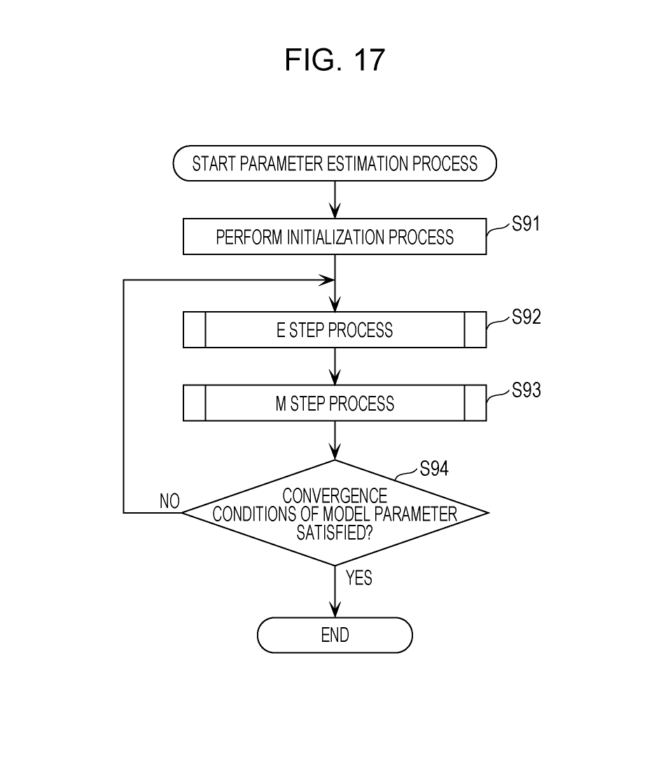

FIG. 17 is a flowchart that illustrates a model parameter estimation process of the FHMM in the electric device estimation apparatus 92.

The parameter estimation unit 922 first performs an initialization process for initializing variables for work and so forth in a parameter estimation process (S91). Specifically, the parameter estimation unit 922 initializes a variation parameter θₜ^{(m)}, the parameter W^{(m)} of the observation probability of the factor m, the covariance matrix C, and a state transition probability A_{i,j}^{(m)} with respect to all times t and factors m (t=1, . . . , T; m=1, . . . , M). An initial value of 1/K is substituted into the variation parameter θₜ^{(m)} and state transition probability A_{i,j}^{(m)}. A prescribed random number is substituted into the parameter W^{(m)} of the observation probability of the factor m as an initial value. An initial value of the covariance matrix C is set to C=al (a is an arbitrary real number, and I is an identity matrix of D rows and D columns (D×D)).

The parameter estimation unit 922 next executes an E step process for performing estimation of the state transition probability (S92). Here, the E step process is a process for performing an E step of an expectation maximization (EM) algorithm, which is an algorithm used for learning of a model including hidden variables. More specifically, the EM algorithm is an algorithm that obtains the optimal solution by alternately repeating estimation in a case where given that a hidden variable and a parameter are present, if one of those is decided, the other is then decided. That is, in the EM algorithm, calculation progresses by alternately repeating the expectation (E) step and a maximization (M) step. Further, the E step process is a process for obtaining the state transition probability of a state in each time by fixing the variation parameter θ.

The parameter estimation unit 922 next executes the M step process for estimating the model parameter (S93). Here, the M step process is the M step of the EM algorithm and a process for calculating the model parameter by fixing the state transition probability of a state. The model parameter calculated in the M step is used in the E step. Details of the M step process will be described later.

The parameter estimation unit 922 then determines the convergence conditions of the model parameter are satisfied (S94). The parameter estimation unit 922 finishes the parameter estimation process in a case where the parameter estimation unit 922 determines that the convergence conditions of the model parameters are satisfied (Yes in S94) but returns to S92 and repeat the process in a case where the convergence conditions are not satisfied (No in S94). For example, in a case where the frequency of repetition of the process of S92 to S94 reaches a prescribed frequency that is predetermined or a case where the variation amount of state likelihood by update of the model parameter is within a prescribed value, the parameter estimation unit 922 determines that the convergence conditions of the model parameter are satisfied.

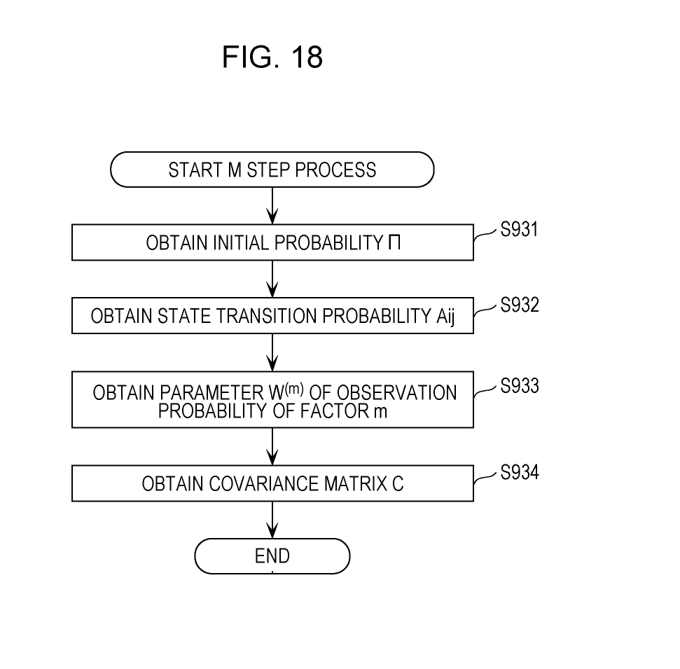

A description will next be made about details of the M step process of S93 with reference to FIG. 18.

FIG. 18 is a flowchart for explaining details of the M step process in S93 of FIG. 17.

In the M step process of S93, the parameter estimation unit 922 first obtains the initial state probability π^{(m)} (S931). More specifically, the parameter estimation unit 922 obtains the initial state probabilities π^{(m)} with respect to all the factors m=1 to M by the following equation (5).

π^{(m)}=<s₁^{(m)} (Equation 5)

The parameter estimation unit 922 next obtains the state transition probabilities A_{i,j}^{(m)} (S932). More specifically, the parameter estimation unit 922 obtains the state transition probabilities A_{i,j}^{(m)} from a state Sⱼ^{(m)} to a state Sᵢ^{(m)} with respect to all the factors m by the following equation (6).

$${A}_{i , j}^{( m )} = \frac{{\sum }_{t = 2}^{T} ( {S}_{t , j}^{( m )} {S}_{t - 1 , j}^{( m )} )}{{\sum }_{t = 2}^{T} ( {S}_{t - 1 , j}^{( m )} )} \qquad ( Equation 6 )$$

Here, the term S_{t-1,j}^{(m)} represents that the state Sⱼ^{(m)} prior to a transition is the state variable Sₜ₋₁^{(m)} at the time t−1 and the term S_{t,i}^{(m)} represents that the state Sᵢ^{(m)} subsequent to a transition is the state variable Sₜ^{(m)} at the time t.

The parameter estimation unit 922 next obtains the parameter W^{(m)} of the observation probability of the factor m (S933). More specifically, the parameter estimation unit 922 obtains the parameter W of the observation probability by the following equation (7).

$$W = ( {\sum }_{t = 1}^{T} {Y}_{t} ( {S}_{t}^{′} ) ) \cdot pinv ( {\sum }_{t = 1}^{T} {S}_{t} ( {S}_{t}^{′} ) ) \qquad ( Equation 7 )$$

In the equation (7), the parameter W of the observation probability represents a matrix of D rows and MK columns (D×MK; MK is the product of M and K), in which M parameters W^{(m)} of D rows and K columns (D×K) are coupled together in the column direction with respect to all the factors m. Accordingly, the parameter W^{(m)} of the observation probability of the factor m may be obtained by decomposing the parameter W of the observation probability in the column direction. Further, the term pinv(•) in the equation (7) is a function for obtaining a pseudo-inverse matrix.

The parameter estimation unit 922 next obtains the covariance matrix C by the following equation (8) (S934).

$$C = \frac{1}{T} {\sum }_{t = 1}^{T} {Y}_{t} {Y}_{t}^{′} - \frac{1}{T} {\sum }_{t = 1}^{T} {\sum }_{m = 1}^{M} {W}^{( m )} ( {S}_{t}^{( m )} ) {Y}_{t}^{′} \qquad ( Equation 8 )$$

As described above, S931 to S934 are performed, a model parameter φ of the FHMM is thereby obtained (updated), and the M step process is finished.

However, because the FHMM is used, the above-described method in related art may not obtain only a local solution as an obtained value of the model parameter, which is different from a global optimal solution, depending on the manner of giving the initial value. Because plural local solutions calculated by using the FHMM are present, results that represent the realistic use states of the electric devices may not be obtained from a state transition array that is estimated from the model parameter of one calculated local solution. That is, even if the use states of the electric devices are estimated from one calculated local solution, the actual use states of the electric devices may not be obtained. In addition, in the above described method in related art, a different value of the model parameter may be provided in each time when calculation is performed. As described above, the above related art has a problem that the accuracy of learning results of the FHMM may be low. Accordingly, results that represent the realistic use states of the electric devices may not be obtained.

Thus, the present inventor(s) found that the characteristics of the power data of target electric devices are provided as prior information, the model parameter that satisfies the conditions in consideration of the characteristics of target power information is estimated, and the model parameter may thereby be calculated by the most suitable learning method of the FHMM for a case of estimating the use states of the electric devices.

A power use state estimation method according to one aspect of the present disclosure includes: acquiring a total value of power consumption of plural electric devices that are connected with a panel board; and estimating a parameter for estimating a model parameter in a case where operating states of the plural electric devices are modeled by a probability model by using the total value, in which in the estimating a parameter, a model parameter in which likelihood that is calculated by a likelihood function becomes a maximum is estimated based on characteristics of power data that are capable of being predetermined as prior knowledge from an operation tendency of each of the plural electric devices, the probability model is a factorial hidden Markov model (factorial HMM), and the likelihood is a value that indicates certainty of a pattern of a total value of the power consumption which is modeled by the factorial HMM with respect to a total value of the power consumption that is actually measured.

Accordingly, a power use state estimation method that may improve the accuracy of learning results of the FHMM may be realized.

Further, for example, the model parameter may include an initial probability, a state transition probability of a latent sequence, and an observation probability that is expressed by an observation average and a covariance.

Here, the likelihood function may be in advance stored in a memory, the estimating a parameter may include: updating the likelihood function by incorporating the characteristics of the power data in the likelihood function; and calculating a model parameter in which the likelihood which is calculated by the likelihood function which is updated in the updating becomes a maximum to estimate the model parameter.

Further, for example, the calculating may calculate two or more model parameters in which the likelihood which is calculated by the likelihood function which is updated by the updating becomes a maximum by being provided with plural initial values, and the estimating a parameter may further include selecting a model parameter in which a self-transition probability is highest from the two or more model parameters which are calculated in the calculating to estimate the model parameter.

Further, for example, the characteristic of the power data may be that an observation value of the power data becomes a total value of power amounts that are output from the plural electric devices, the estimating a parameter may include: calculating two or more model parameters in which the likelihood becomes a maximum by being provided with plural initial values; and selecting a model parameter in which a total of the observation averages becomes the observation value of the power data from the two or more model parameters that are calculated by the calculating based on the characteristics of the power data to estimate the model parameter.

Further, for example, the characteristic of the power data may indicate a tendency in which the plural electric devices are simultaneously used, and the estimating a parameter may include: calculating two or more model parameters in which the likelihood becomes a maximum by being provided with plural initial values; estimating a state transition array for estimating two or more state transition arrays from the two or more model parameters that are calculated in the calculating and observation data; and selecting a model parameter that estimates the state transition array in which times in which the plural electric devices are simultaneously used are most from the two or more state transition arrays which are estimated by the estimating a state transition array based on the characteristics of the power data to estimate the model parameter.

Further, a power use state estimation apparatus according to one aspect of the present disclosure includes a parameter estimation unit that estimates a model parameter in a case where operating states of plural electric devices are modeled by a probability model by using the total value of power consumption of the plural electric devices that are connected with a panel board, in which the probability model is a factorial HMM, the parameter estimation unit estimates a model parameter in which likelihood that is calculated by a likelihood function becomes a maximum based on characteristics of power data that are capable of being predetermined as prior knowledge from an operation tendency of each of the plural electric devices, and the likelihood is a value that indicates certainty of a pattern of a total value of the power consumption which is modeled by the factorial HMM with respect to a total value of the power consumption that is actually measured.

It should be noted that general or specific embodiments may be implemented as a system, a method, an integrated circuit, a computer program, or a computer-readable recording medium such as a CD-ROM, or any selective combination thereof.

A detailed description will be made below about a power use state estimation apparatus and so forth according to one aspect of the present disclosure with reference to drawings.

It should be noted that all the embodiments described below merely illustrate specific examples of the present disclosure. Values, shapes, materials, configuration elements, arrangement positions of configuration elements, and so forth that are described in the following embodiments are merely illustrative and are not intended to limit the present disclosure. Further, the configuration elements that are not described in the independent claims that provide the most superordinate concepts among the configuration elements in the following embodiments will be described as arbitrary configuration elements.

Embodiments of the present disclosure will hereinafter be described with reference to drawings.

### First Embodiment

### General Configuration of System

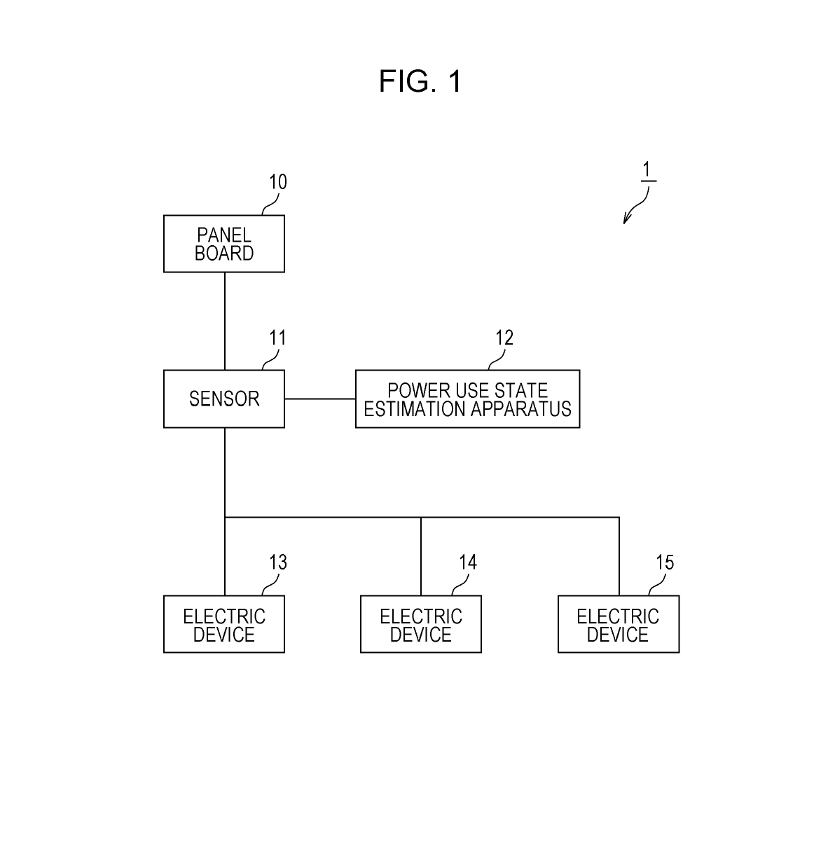

FIG. 1 is a diagram that illustrates a configuration of a system 1 in a first embodiment.

The system 1 illustrated in FIG. 1 includes a panel board 10, a sensor 11, a power use state estimation apparatus 12, an electric device 13, an electric device 14, and an electric device 15.

The panel board 10 supplies the power supplied from an external power supply company to the electric device 13 to electric device 15, the power use state estimation apparatus 12, and so forth, which are connected with the panel board 10.

The electric device 13 to electric device 15 are plural electric devices connected with the panel board 10, such as an illumination device, an air conditioner, and a washing machine.

The sensor 11 measures, at the panel board 10 as a root, the total value of the power consumption of the electric device 13 to electric device 15 that are installed in respective places in a residence. Here, the total value of the power consumption of the electric device 13 to electric device 15 corresponds to the total value of the power consumption derived from the combinations of use states of the electric device 13 to electric device 15. The sensor 11 accumulates the measured total value of the power consumption (power data) as time series data and supplies the total value to the power use state estimation apparatus 12.

The power use state estimation apparatus 12 estimates a power use state of each of the electric device 13 to electric device 15. In this embodiment, the power use state estimation apparatus 12 learns a model parameter of the FHMM from the power data supplied from the sensor 11. Further, the power use state estimation apparatus 12 estimates future power use states by the learned model parameter in a case where the electric device 13 to electric device 15 and so forth newly use power.

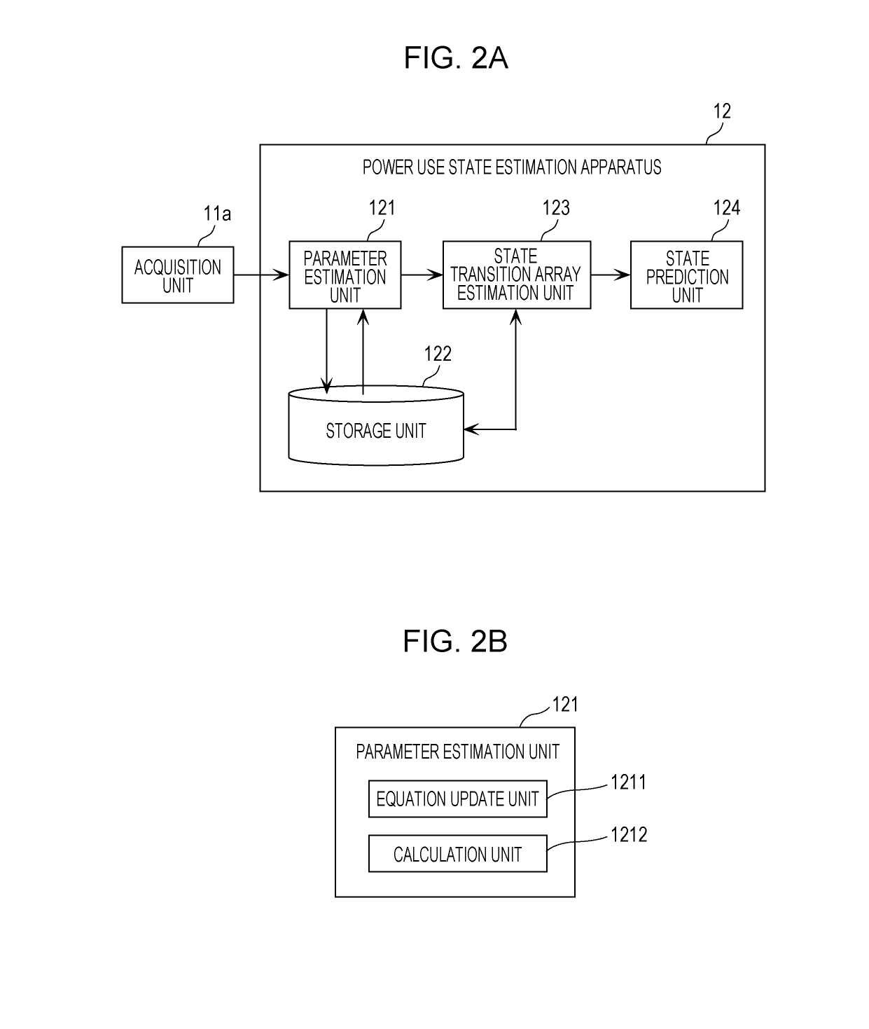

A description will next be made about details of the power use state estimation apparatus 12 with reference to FIG. 2A and FIG. 2B.

### [Configuration of Power Use State Estimation Apparatus]

FIG. 2A is a block diagram that illustrates one example of a configuration of the power use state estimation apparatus 12 in the first embodiment. FIG. 2B is a block diagram that illustrates one example of a specific configuration of a parameter estimation unit 121 of FIG. 2A.

As illustrated in FIG. 2A, the power use state estimation apparatus 12 includes a parameter estimation unit 121, a storage unit 122, a state transition array estimation unit 123, and a state prediction unit 124.

An acquisition unit 11a acquires the total value (power data) of the power consumption of the plural electric devices that are connected with the panel board 10. In this embodiment, the acquisition unit 11a acquires observation data {Y₁, Y₂, Y₃, . . . , Yₜ, . . . , Y_{T}}, which are time-series power data of the total values of the power consumption of the plural electric devices (the electric device 13 to electric device 15) and are measured by the sensor 11. The acquisition unit 11a may be integral with the sensor 11 or may be a separate body. In a case where the acquisition unit 11a is integral with the sensor 11, the observation data measured by the sensor 11 may be supplied to the parameter estimation unit 121. Further, the power use state estimation apparatus 12 may include the acquisition unit 11a.

The parameter estimation unit 121 uses the total values of the power consumption of the plural electric devices that are connected with the panel board 10 to estimate a model parameter in a case where operating states of the plural electric devices are modeled by a probability model. The parameter estimation unit 121 estimates the model parameter in which the likelihood calculated by a likelihood function becomes a maximum based on characteristics of the power data that may be predetermined as prior knowledge from an operation tendency of each of the plural electric devices. Here, a probability model is a factorial hidden Markov model (FHMM), and likelihood is a value that indicates the certainty of the pattern of the total value of the power consumption of the plural electric devices, which is modeled by the FHMM, with respect to the total value of the power consumption that is actually measured. The model parameter includes an initial probability, a state transition probability of a latent sequence, and an observation probability expressed by an observation average and a covariance.

In this embodiment, the parameter estimation unit 121 estimates the model parameter in which the operating states of the plural electric devices (the electric device 13 to electric device 15) are modeled by the FHMM based on the observation data {Y₁, Y₂, Y₃, . . . , Yₜ, . . . , Y_{T}} acquired by the acquisition unit 11a. The parameter estimation unit 121 saves the estimated model parameter, that is, the model parameter obtained by the learning process of the FHMM in the storage unit 122. More specifically, as illustrated in FIG. 2B, the parameter estimation unit 121 includes an equation update unit 1211 and a calculation unit 1212.

The equation update unit 1211 updates the likelihood function by incorporating the characteristics of the power data in the likelihood function. Here, the likelihood function is in advance stored and is in advance stored in the storage unit 122, for example. Although details will be described later, the equation update unit 1211 uses the characteristics of the power data that the plural electric devices (the electric device 13 to electric device 15) are continuously used and the state transition between ON and OFF does not frequently occur, as prior information, and thereby updates the likelihood function that is in advance stored in the storage unit 122 so as to obtain the likelihood function in which a self-transition probability is high.

The calculation unit 1212 estimates the model parameter by calculating the model parameter, in which the likelihood calculated by the likelihood function updated by the equation update unit 1211 becomes a maximum.

The storage unit 122 in advance stores the likelihood function. Further, the storage unit 122 stores the model parameter estimated by the parameter estimation unit 121.

The state transition array estimation unit 123 estimates a state transition array formed with M factors from the model parameter stored in the storage unit 122 and the observation data {Y₁, Y₂, Y₃, . . . , Yₜ, . . . , Y_{T}} acquired by the acquisition unit 11a by the Viterbi algorithm. The M factors represent the use states of ON and OFF of the individual electric devices, for example.

The state prediction unit 124 displays the present operating state of each of the electric device 13 to electric device 15 and predicts the future operating states of the electric device 13 to electric device 15 at the time after a prescribed time elapses from the present time, based on the estimation results of the state transition array estimation unit 123.

### [Operation of Power Use State Estimation Apparatus]

A description will next be made about an operation of the power use state estimation apparatus 12 configured as described above.

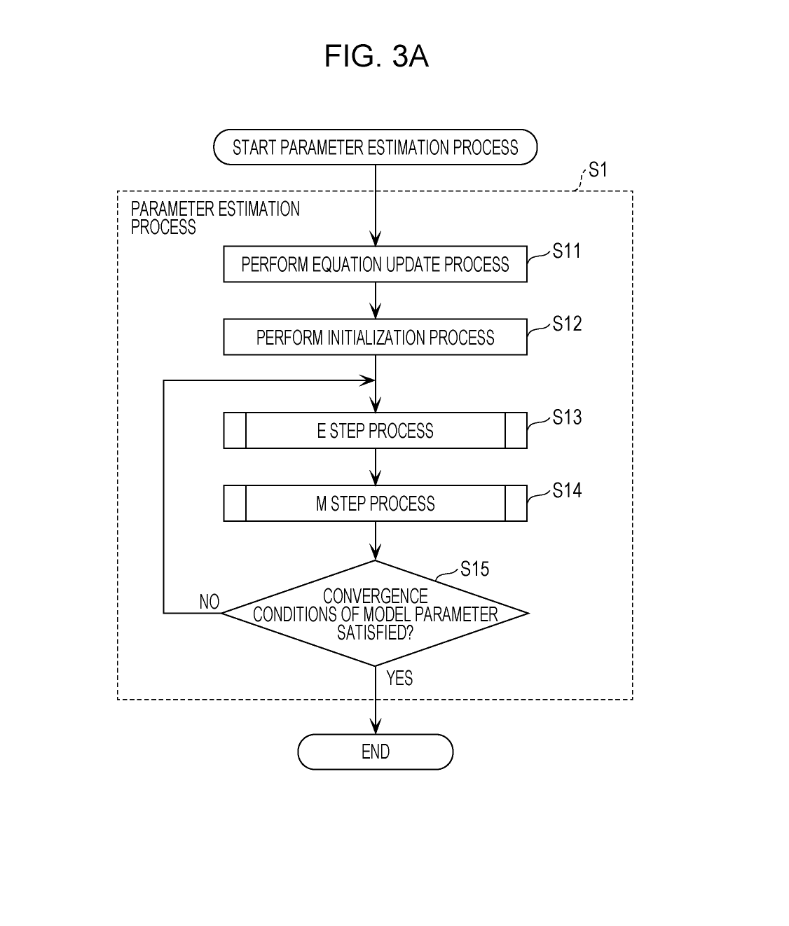

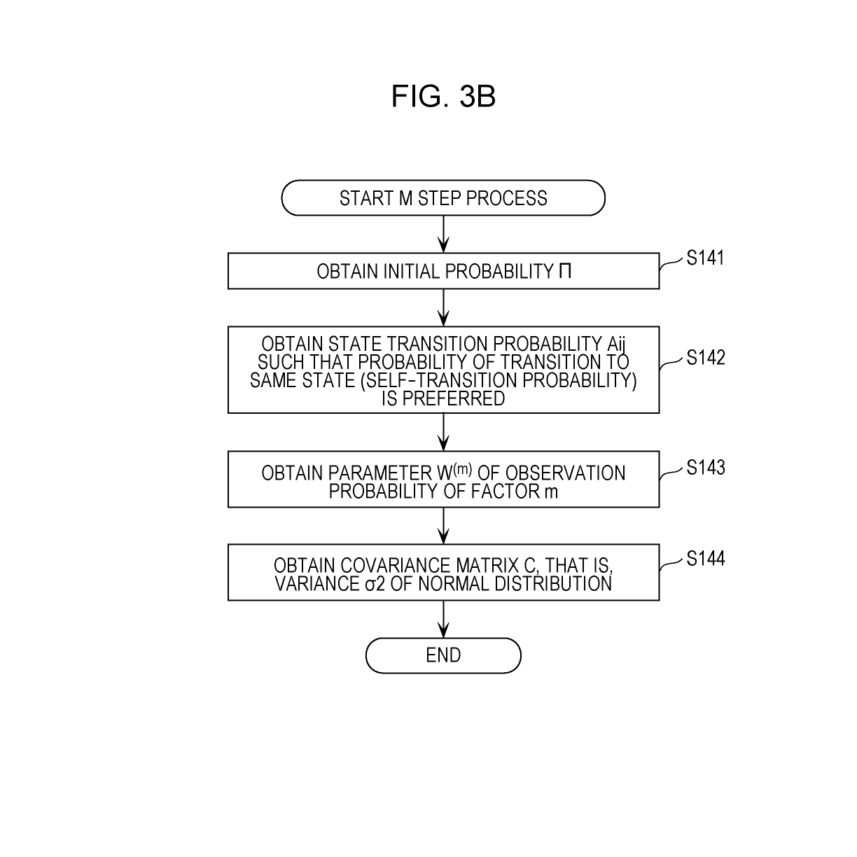

FIG. 3A is a flowchart that illustrates a model parameter estimation process of the FHMM in the power use state estimation apparatus 12 in the first embodiment. FIG. 3B is a flowchart for explaining details of the M step process in S14 in FIG. 3A.

The parameter estimation unit 121 first performs an equation update process by using the prior information (S11). In this embodiment, the parameter estimation unit 121 updates the likelihood function by incorporating the characteristics of the power data in the likelihood function. More specifically, the parameter estimation unit 121 incorporates the characteristics of the power data that may be predetermined as the prior knowledge from the operation tendency of each of the plural electric devices in the likelihood function and thereby updates the likelihood function to the likelihood function in which the self-transition probability is high.

The parameter estimation unit 121 next performs an initialization process for initializing variables for work and so forth in the parameter estimation process (S12). The specific process is described in S91 and will not be described here.

The parameter estimation unit 121 next executes the E step process for performing estimation of the state transition probability (S13). The specific process is described in S92 and will not be described here.

The parameter estimation unit 121 next executes the M step process for estimating the model parameter (S14). The process in S14 is different from S93 in the point that the M step process is performed by using the updated likelihood function and will thus be described with reference to FIG. 3B. The processes of S141, S143, and S144 illustrated in FIG. 13B are the same as the above-described processes of S931, S933, and S934 and will thus not be described.

In S142, the parameter estimation unit 121 obtains the state transition probability A_{i,j}^{(m)} such that the probability of a transition to the same state (self-transition probability) is preferred. More specifically, the parameter estimation unit 121 obtains the state transition probabilities A_{i,j}^{(m)} from the state Sⱼ^{(m)} to the state Sⱼ^{(m)} with respect to all the factors m by the following equation (9).

$${A}_{i , j}^{( m )} = \{ \begin{matrix}\frac{{\sum }_{t = 2}^{T} ( {S}_{t , j}^{( m )} {S}_{t - 1 , j}^{( m )} ) + α}{{\sum }_{t = 2}^{T} ( {S}_{t - 1 , j}^{( m )} ) + α} & i = j \\ \frac{{\sum }_{t = 2}^{T} ( {S}_{t , j}^{( m )} {S}_{t - 1 , j}^{( m )} )}{{\sum }_{t = 2}^{T} ( {S}_{t - 1 , j}^{( m )} ) + α} & i \neq j\end{matrix} \qquad ( Equation 9 )$$

The equation (9) is used, and calculation may be performed such that the probability of a transition to the same state is high, in a case where the state transition probability is obtained in the M step process. More specifically, in a case where the number of states is two, for example, the likelihood function is updated such that the probabilities of state transitions from ON to ON and from OFF to OFF are high. In the equation (9), the likelihood function is updated to the likelihood function in which a is added to the numerator and the denominator in the case of i=j and to the denominator in the case of i≠j. Details of such a sticky HMM are described in Tadahiro Taniguchi (Ritsumeikan University), Keita Hamahata (Ritsumeikan University), and Naoto Iwahashi (National Institute of Information and Communications Technology), “Imitation Learning Method for Unsegmented Motion Using Hierarchical Dirichlet Process Hidden Markov Model”, Collection of Papers of Conference of the Society of Instrument of Control Engineers, Systems and Information Division (CD-ROM): p. 2010: ROMBUNNO. 1A1-5.

The model parameter in which the likelihood becomes a maximum is calculated by using the likelihood function updated as described above. In other words, in S142, the parameter estimation unit 121 calculates the model parameter in which the likelihood becomes a maximum by using the likelihood function that is updated such that the probability of a transition to the same state is made higher than the probability of a transition to other states. Accordingly, the state transition array in which switching between ON and OFF less frequently occurs may be estimated, and results closer to the real use states of the electric devices may thereby be obtained.

### [Effects]

A power use state estimation method and so forth of this embodiment may improve the accuracy of learning results of the FHMM.

More specifically, the characteristics of the power data of the electric devices that the electric devices are continuously used and the state transition between ON and OFF does not frequently occur are provided as the prior information, and the model parameter that satisfies the conditions in consideration of the characteristics of power information is thereby estimated. Accordingly, the model parameter may be calculated by the learning method of the FHMM that is most suitable for a case where realistic (actual) use states of the electric devices are estimated, and the accuracy of learning results of the FHMM may thus be improved.

Accordingly, in the power use state estimation method of this embodiment, calculation of the model parameter for estimating the operating states of the electric devices and the operation patterns associated therewith and for predicting future states may highly accurately performed based on the acquired time-series power data (data of currents, voltages, or the like) of the electric devices without requesting prior registration of the electric device in a database.

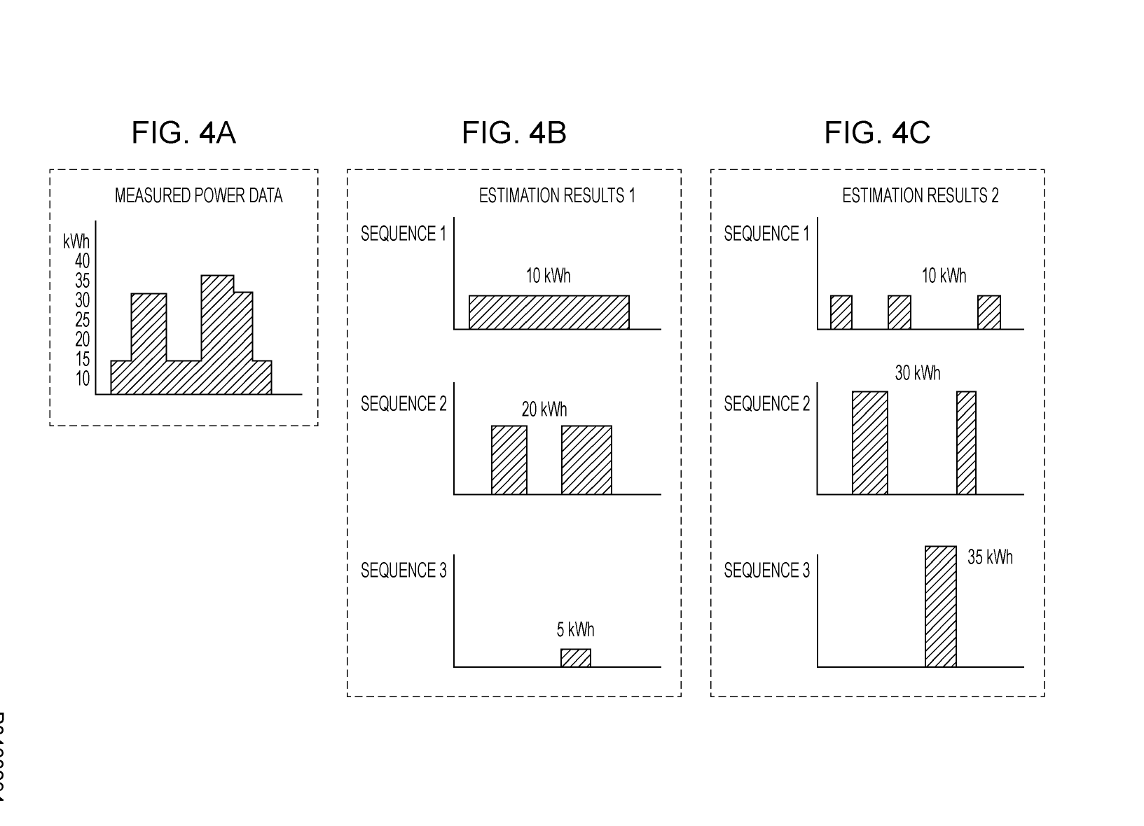

FIG. 4A to FIG. 4C are diagrams for explaining effects of the first embodiment. FIG. 4A illustrates examples of the power data that are measured by the sensor 11 and acquired by the acquisition unit 11a. FIG. 4B and FIG. 4C illustrate examples of estimation results in a case where the power use states of the three electric devices are estimated from the power data illustrated in FIG. 4A by the FHMM with the number of factors M=3. Each of a sequence 1 to a sequence 3 represents any one of the three electric devices.

In estimation results 1 illustrated in FIG. 4B, the parameters W^{(m)} of the observation probability are estimated to be 5 kWh, 10 kWh, and 20 kWh. In estimation results 2 illustrated in FIG. 4C, the parameters W^{(m)} of the observation probability are estimated to be 10 kWh, 30 kWh, and 35 kWh. The state transition array obtained by either one of the model parameters may represent the power data illustrated in FIG. 4A. As described above, the FHMM is apt to obtain a local solution that does not correspond to the reality but has high likelihood, depending on random numbers that are used in initial setting of the EM algorithm. In a case where the correct solution is not identified, which model parameter is the optimal solution as a realistic solution may not be identified. That is, in related art, whether the value of the obtained model parameter is a global optimal solution or a local solution which is different from the global optimal solution may not be identified, depending on the manner of giving the initial value.

However, considering general usage of electric devices, there are electric devices such as refrigerators that are kept turned on throughout a day, electric devices such as illumination instruments and air conditioners that are turned on for certain periods such as in the night and when someone is at home, electric devices such as rice cookers and TVs that are continuously used for several ten minutes, and electric devices such as microwave ovens and dryers that are used for several minutes. Any of the electric devices is switched between ON and OFF one to several times during a day. That is, as the characteristics of the power data of the electric devices, it may be considered that the electric devices are continuously used and the state transitions between ON and OFF do not frequently occur.

Based on such characteristics of the power data, it may be considered that the model parameters estimated by the FHMM, which have the state transition probability that a state transition easily occurs, in which the values of an observation sequence are not expressed as combinations of the components of columns of the parameters W^{(m)} of the observation probability or as the sum of all the components, and in which the factors are not likely to be simultaneously ON, are not suitable as a realistic solution (not a global optimal solution).

Thus, the power use state estimation apparatus 12 and so forth of this embodiment use the likelihood function that incorporates the characteristics of the power data of the electric devices as the prior information to calculate the model parameter of the FHMM. Accordingly, the parameter of the observation probability of the estimation results 1 illustrated in FIG. 4B, in which the state transitions between ON and OFF do not frequently occur, may be estimated.

As described in S142 of FIG. 3B, for example, the description is made that the power use state estimation apparatus 12 and so forth of this embodiment use the likelihood function that is updated such that the self-transition probability is high to calculate the state transition probability. However, embodiments are not limited thereto. Instead of obtaining the self-transition probability, the state transition probability may be calculated by using an equation for obtaining the parameter W^{(m)} of the observation probability or the equation in which the values of the observation sequence become the combinations of the components of columns of the parameters W^{(m)} of the observation probability or the sum of all the components.

### Modification Example

The description is made that the power use state estimation apparatus 12 and so forth of the first embodiment use the likelihood function that incorporates the characteristics of the power data of the electric devices as the prior information to calculate one model parameter of the FHMM and thereby estimate the model parameter. However, embodiments are not limited thereto. There may be a case where two or more solutions (model parameters) are calculated in a calculation procedure of the model parameter of the FHMM. Such a case will be described as a modification example.

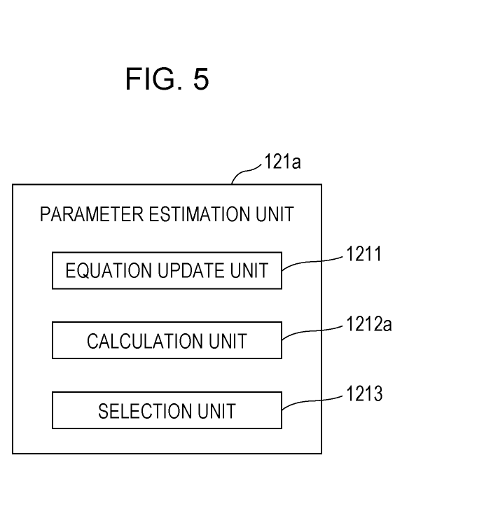

FIG. 5 is a block diagram that illustrates one example of a configuration of a parameter estimation unit 121a according to a modification example of the first embodiment. The same reference numerals are provided to the same configuration elements as FIG. 2B, and a description thereof will not be made.

The parameter estimation unit 121a illustrated in FIG. 5 includes the equation update unit 1211, a calculation unit 1212a, and a selection unit 1213. The parameter estimation unit 121a illustrated in FIG. 5 is different from the parameter estimation unit 121 according to the first embodiment in the configuration of the calculation unit 1212a, and the selection unit 1213 is added.

The calculation unit 1212a is provided with plural initial values and thereby calculates two or more model parameters in which the likelihood calculated by the likelihood function updated by the equation update unit 1211 becomes a maximum.

The selection unit 1213 estimates the model parameter by selecting the model parameter in which the self-transition probability is highest from the two or more model parameters calculated by the calculation unit 1212a.

Accordingly, even in a case where the power use state estimation apparatus 12 and so forth according to the modification example of the first embodiment calculate two or more model parameters in the calculation procedure of the model parameter of the FHMM, one model parameter may be selected based on the characteristics of the power data of the electric devices, which are provided as the prior information, and the model parameter may thus be selected.

### Second Embodiment

In the first embodiment, the description is made about estimation of the model parameter of the FHMM by using the likelihood function that incorporates the characteristics of the power data of the electric devices as the prior information. However, embodiments are not limited thereto. In a second embodiment, a description will be made about a method and so forth of estimating the model parameter of the FHMM based on the prior information that indicates the characteristics of the power data of the electric devices by a different method from the first embodiment.

### [Configuration of Power Use State Estimation Apparatus]

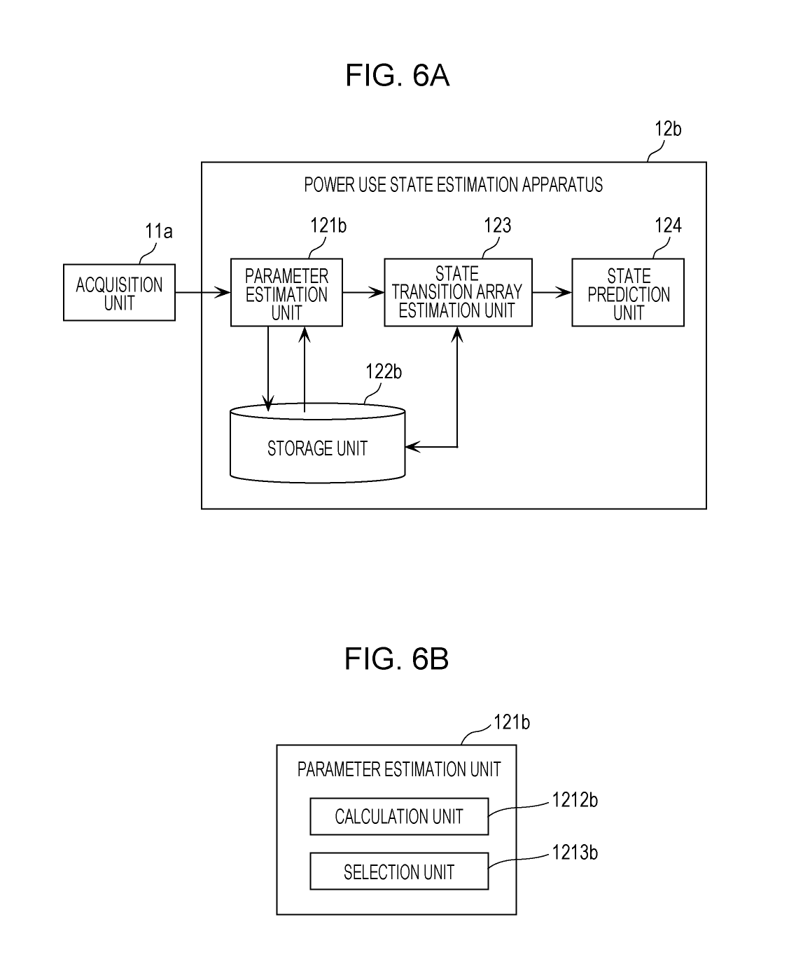

FIG. 6A is a block diagram that illustrates one example of a configuration of a power use state estimation apparatus 12b in the second embodiment. FIG. 6B is a block diagram that illustrates one example of a specific configuration of a parameter estimation unit 121b in FIG. 6A. In FIG. 6A and FIG. 6B, the same reference characters are provided to the same configuration elements as FIG. 2A and FIG. 2B, and a description thereof will not be made.

As illustrated in FIG. 6A, the power use state estimation apparatus 12b includes the parameter estimation unit 121b, a storage unit 122b, the state transition array estimation unit 123, and the state prediction unit 124.

The power use state estimation apparatus 12b illustrated in FIG. 6A is different from the power use state estimation apparatus 12 according to the first embodiment in the configurations of the parameter estimation unit 121b and the storage unit 122b.

The parameter estimation unit 121b uses the total values of the power consumption of plural electric devices that are connected with the panel board 10 to estimate a model parameter in a case where operating states of the plural electric devices are modeled by a probability model. The parameter estimation unit 121b estimates the model parameter in which the likelihood calculated by the likelihood function becomes a maximum based on characteristics of the power data that may be predetermined as prior knowledge from an operation tendency of each of the plural electric devices.

In this embodiment, the parameter estimation unit 121b estimates the model parameter in which the operating states of the plural electric devices (the electric device 13 to electric device 15) are modeled by the FHMM based on the observation data acquired by the acquisition unit 11a. The parameter estimation unit 121b saves the estimated model parameter, that is, the model parameter obtained by the learning process of the FHMM in the storage unit 122b. More specifically, as illustrated in FIG. 6B, the parameter estimation unit 121b includes a calculation unit 1212b and a selection unit 1213b.

The calculation unit 1212b is provided with plural initial values and thereby calculates two or more model parameters in which the likelihood becomes a maximum. In this embodiment, the calculation unit 1212b temporarily saves the two or more calculated model parameters in the storage unit 122b.

The selection unit 1213b selects the model parameter, in which the total of the observation averages becomes the observation value of the power data, from the two or more model parameters calculated by the calculation unit 1212b based on the characteristics of the power data and thereby estimates the model parameter. Here, the characteristic of the power data is that the observation value of the power data becomes the total value of the power amounts output from the plural electric devices, for example. In this embodiment, the selection unit 1213b selects the model parameter that is most suitable for the characteristics of the power data from the two or more model parameters that are saved in the storage unit 122b and are obtained from plural initial values. The selection unit 1213b deletes the model parameters other than the selected model parameter, among the two or more model parameters that are saved in the storage unit 122b.

The storage unit 122b temporarily stores two or more model parameters that are calculated by the calculation unit 1212b. Further, the storage unit 122b stores the model parameter that is selected by the selection unit 1213b.

### [Operation of Power Use State Estimation Apparatus]

A description will next be made about an operation of the power use state estimation apparatus 12b configured as described above.

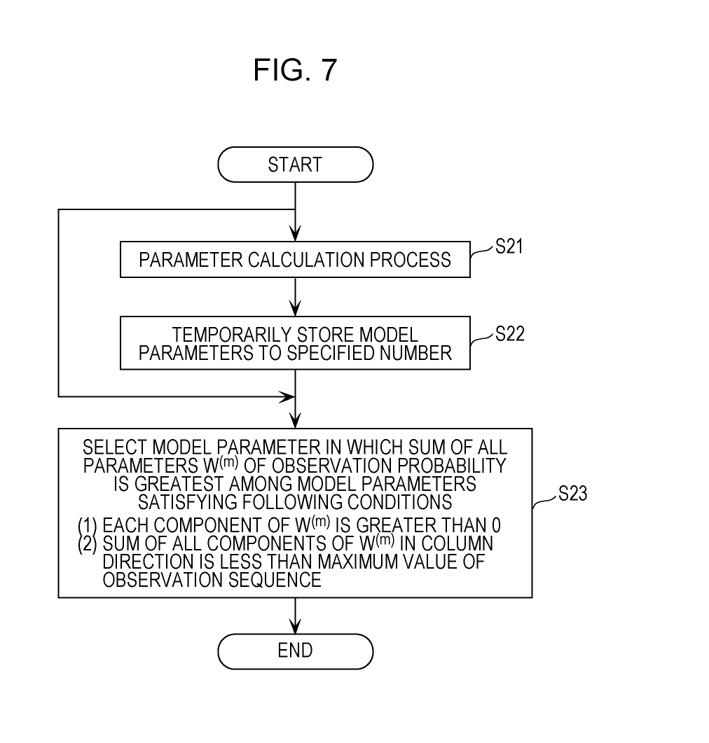

FIG. 7 is a flowchart that illustrates a model parameter estimation process of the FHMM in the power use state estimation apparatus 12b in the second embodiment.

The parameter estimation unit 121b first executes a parameter calculation process (S21). Specifically, the process of S12 to S15 illustrated in FIG. 3A is performed. However, in S12, the initialization process is carried out with different random numbers (initial values) plural times. That is, the process of S13 to S15 is repeated at each time when the initialization process is carried out in S12. As a result, the parameter estimation unit 121b calculates two or more model parameters.

Next, the storage unit 122b temporarily stores model parameters to a specified number (S22). Specifically, the parameter estimation unit 121b causes the storage unit 122b to store two or more model parameters that are calculated in S21. Using different random numbers in the initialization process may result in two or more calculated model parameters. In this embodiment, a description is made that two or more parameters are present.

The parameter estimation unit 121b next selects one model parameter from the two or more model parameters calculated in S21 based on the characteristics of the power data (S23). In this embodiment, the parameter estimation unit 121b selects one from the two or more model parameters stored in the storage unit 122b. For example, the parameter estimation unit 121b selects the model parameter, in which the total of probability averages (observation probability averages) becomes the observation value of the power data, based on the characteristics of the power data. Specifically, the parameter estimation unit 121b selects the model parameter in which the sum of all W^{(m)} is greatest from the model parameters, in which (1) each component of the parameter W^{(m)} of the probability average (observation probability average) is greater than zero and (2) the sum of all the parameters W^{(m)} of the probability average (observation probability average) is less than the maximum value of the observation sequence, among the two or more model parameters stored in the storage unit 122b. One example of this selection method means that the model parameter that is the solution, in which the frequency of switching between ON and OFF of the electric devices is lowest, is selected based on the characteristics of the power data of the electric devices. The conditions of (1) are for removing the model parameters that are solutions in which all the electric devices are OFF. The conditions of (2) are for removing the model parameters that are solutions in which all the electric devices are ON.

In a case where using different random numbers in the initialization process results in one pattern of the calculated model parameter and the model parameter stored in the storage unit 122b is one pattern, it goes without saying that the model parameter is selected.

### [Effects]

A power use state estimation method and so forth of this embodiment may improve the accuracy of learning results of the FHMM.

More specifically, in the power use state estimation method and so forth of this embodiment, one most suitable solution may be selected from the two or more model parameters that are calculated by using plural random numbers in the initialization process. Accordingly, the state transition array in which switching between ON and OFF less frequently occurs may be estimated, and results closer to the real use states of the electric devices may thereby be obtained.

### Third Embodiment

In a third embodiment, a description will be made about a method and so forth of estimating the model parameter of the FHMM based on the prior information that indicates the characteristics of the power data of the electric devices by a different method from the second embodiment.

### [Configuration of Power Use State Estimation Apparatus]

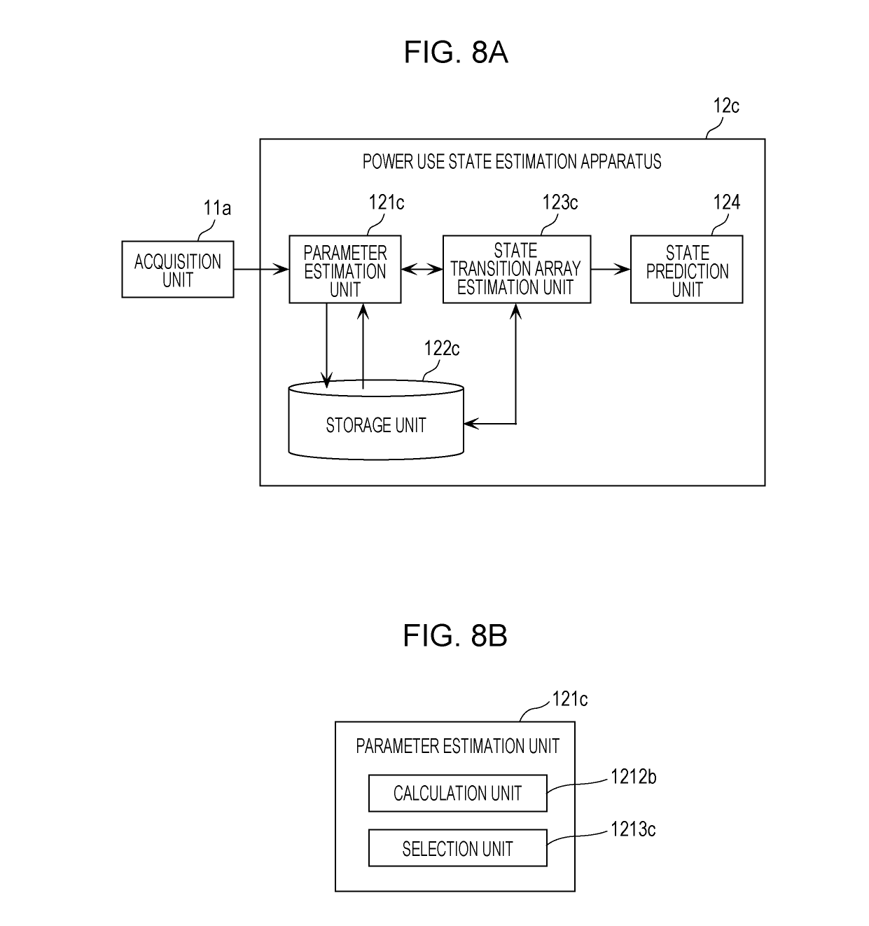

FIG. 8A is a block diagram that illustrates one example of a configuration of a power use state estimation apparatus 12c in the third embodiment. FIG. 8B is a block diagram that illustrates one example of a specific configuration of a parameter estimation unit 121c of FIG. 8A. The same reference characters are provided to the same configuration elements as FIG. 2A, FIG. 2B, and FIG. 6B, and a description thereof will not be made.

As illustrated in FIG. 8A, the power use state estimation apparatus 12c includes a parameter estimation unit 121c, a storage unit 122c, a state transition array estimation unit 123c, and the state prediction unit 124.

The power use state estimation apparatus 12c illustrated in FIG. 8A is different from the power use state estimation apparatus 12 according to the first embodiment in the configurations of the parameter estimation unit 121c, the storage unit 122c, and the state transition array estimation unit 123c.

The state transition array estimation unit 123c estimates two or more state transition arrays from two or more model parameters that are calculated by the parameter estimation unit 121c and the observation data. In this embodiment, the state transition array estimation unit 123c estimates plural state transition arrays from two or more model parameters stored in the storage unit 122c and the observation data acquired by the acquisition unit 11a by the Viterbi algorithm. The state transition array estimation unit 123c stores plural estimated state transition arrays in the storage unit 122c. Further, the state transition array estimation unit 123c supplies the state transition array that is selected by the parameter estimation unit 121c among the estimated plural state transition arrays to the state prediction unit 124.

The parameter estimation unit 121c uses the total values of the power consumption of plural electric devices that are connected with the panel board 10 to estimate a model parameter in a case where operating states of the plural electric devices are modeled by a probability model. The parameter estimation unit 121c estimates the model parameter in which the likelihood calculated by the likelihood function becomes a maximum based on characteristics of the power data that may be predetermined as prior knowledge from an operation tendency of each of the plural electric devices.

In this embodiment, the parameter estimation unit 121c estimates the model parameter in which the operating states of the plural electric devices (the electric device 13 to electric device 15) are modeled by the FHMM based on the observation data acquired by the acquisition unit 11a. The parameter estimation unit 121c saves the estimated model parameter, that is, the model parameter obtained by the learning process of the FHMM in the storage unit 122c. More specifically, as illustrated in FIG. 8B, the parameter estimation unit 121c includes the calculation unit 1212b and a selection unit 1213c.

The calculation unit 1212b is provided with plural initial values and thereby calculates two or more model parameters in which the likelihood becomes a maximum. In this embodiment, the calculation unit 1212b temporarily saves the two or more calculated model parameters in the storage unit 122c.

The selection unit 1213c selects the model parameter, which estimates the state transition array in which the times of simultaneous use of the plural electric devices are most, from the two or more state transition arrays that are estimated by the state transition array estimation unit 123c based on the characteristics of the power data and thereby estimates the model parameter. In this embodiment, the selection unit 1213c selects the model parameter that has the most state sequences in which the electric devices are simultaneously in an ON state from the plural state transition arrays stored in the storage unit 122c.

The storage unit 122c temporarily stores the two or more model parameters that are calculated by the calculation unit 1212b and temporarily stores the plural state transition arrays that are estimated by the state transition array estimation unit 123c. The storage unit 122c stores the state transition array that is selected by the selection unit 1213c and the model parameter thereof.

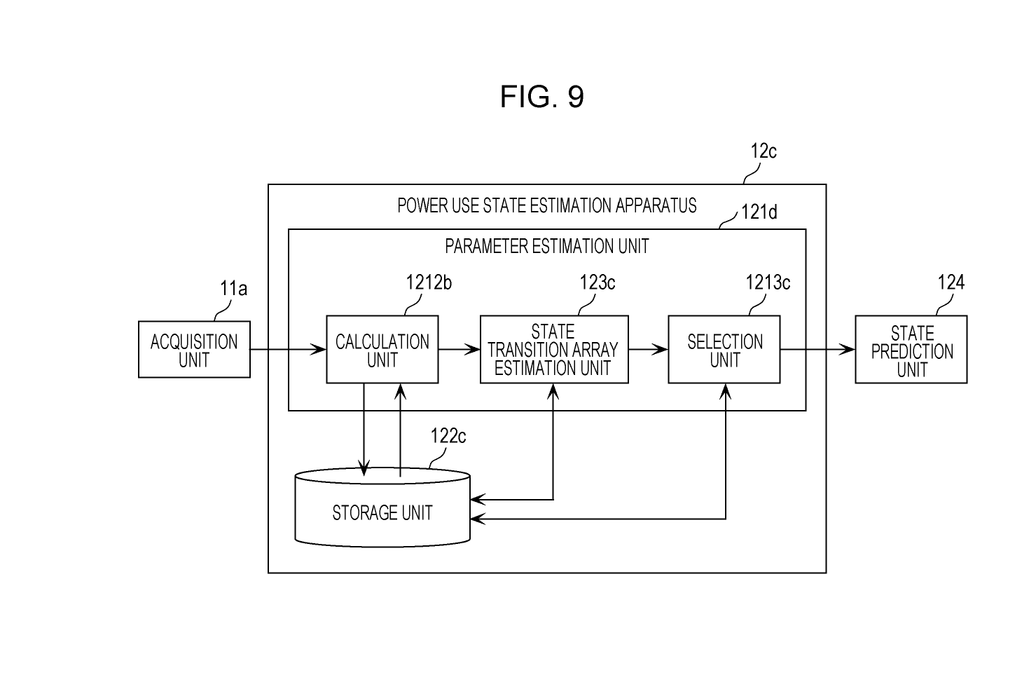

Configuration examples of the parameter estimation unit 121c and the state transition array estimation unit 123c are not limited to those illustrated in FIG. 8A. For example, a configuration illustrated in FIG. 9 is possible. FIG. 9 is a block diagram that illustrates another example of the configuration of the power use state estimation apparatus 12c in the third embodiment. The same reference characters are provided to the same configuration elements as FIG. 8A and FIG. 8B, and a description thereof will not be made. That is, as a parameter estimation unit 121d illustrated in FIG. 9, the calculation unit 1212b, the state transition array estimation unit 123c, and the selection unit 1213c may be included.

### [Operation of Power Use State Estimation Apparatus]

A description will next be made about an operation of the power use state estimation apparatus 12c configured as described above.

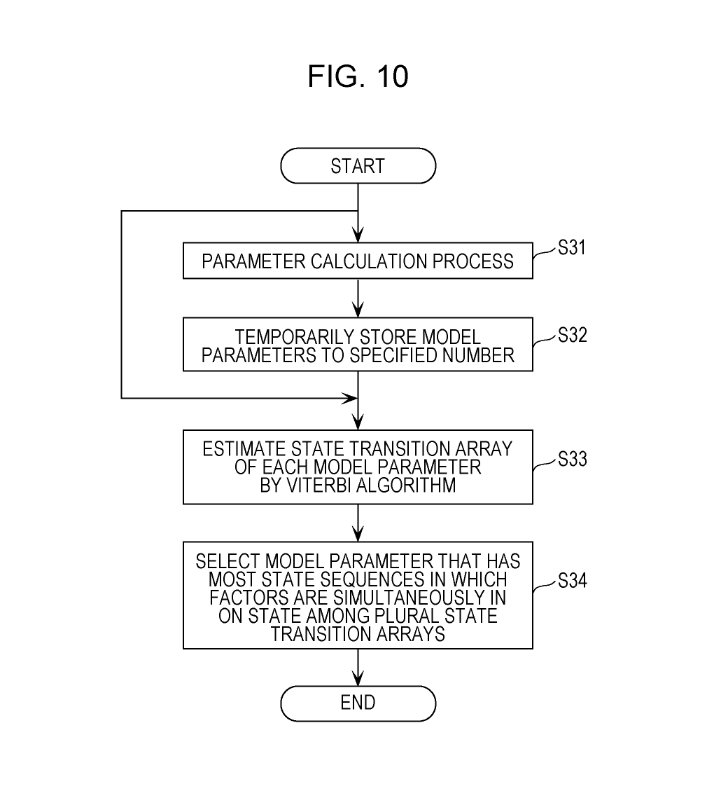

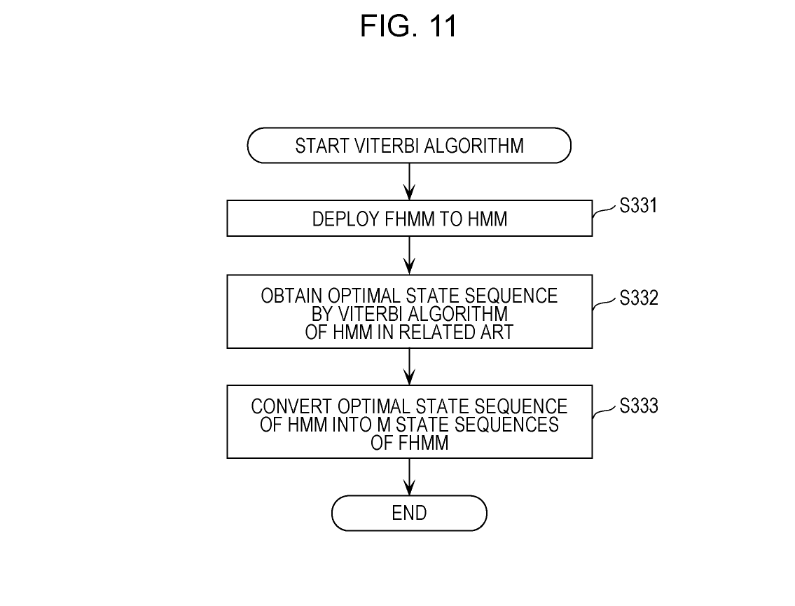

FIG. 10 is a flowchart that illustrates a model parameter estimation process of the FHMM in the power use state estimation apparatus 12c in the third embodiment. FIG. 11 is a flowchart that illustrates a process of the Viterbi algorithm.

First, processes in S31 and S32 are similar to S21 and S22 illustrated in FIG. 7, and a description thereof will not be made.

Next, in S33, the state transition array estimation unit 123c estimates state transition arrays by the Viterbi algorithm. More specifically, the state transition array estimation unit 123c estimates state transition arrays by the Viterbi algorithm illustrated in FIG. 11 with respect to each of model parameters stored in the storage unit 122c. The state transition array estimation unit 123c stores two or more estimated state transition arrays in the storage unit 122c.

Here, the Viterbi algorithm will be described. That is, as illustrated in FIG. 11, the state transition array estimation unit 123c first deploys the values set in the initialization process of the FHMM to initial values of the HMM (S331). For example, in a case of the FHMM in which the number of factors is M and the number of states of each of the factors is K, the state transition array estimation unit 123c deploys the FHMM to the HMM that has K^{M} (K to the Mth power) states. The state transition array estimation unit 123c next obtains state sequences by the Viterbi algorithm of the HMM in related art (S332). A specific calculation method is disclosed in C. M. Bishop, “Pattern Recognition and Machine Learning” (Japanese Translation) Volume 2, Chapter 13, p. 347, and a description thereof will not be made here. The state transition array estimation unit 123c next converts the state sequences of the HMM obtained in S332 into M state sequences of the FHMM (S333). A specific calculation method is disclosed in Lee Dongheui, Kulic Dana, and Yoshihiko Nakamura, “Whole Motion Recovery from Partial Observation Data using Factorial Hidden Markov Models”, Proceedings of Conference on Robotics and Mechatronics 2008, “1P1-G20(1)”-“1P1-G20(4)”, 2008 Jun. 6, and a description thereof will not be made here.

Next, in S34, the parameter estimation unit 121c selects the state transition array, which has the most state sequences in which the electric devices are simultaneously in the ON state, from the two or more state transition arrays stored in the storage unit 122c and selects the model parameter that is used to estimate the selected state transition array.

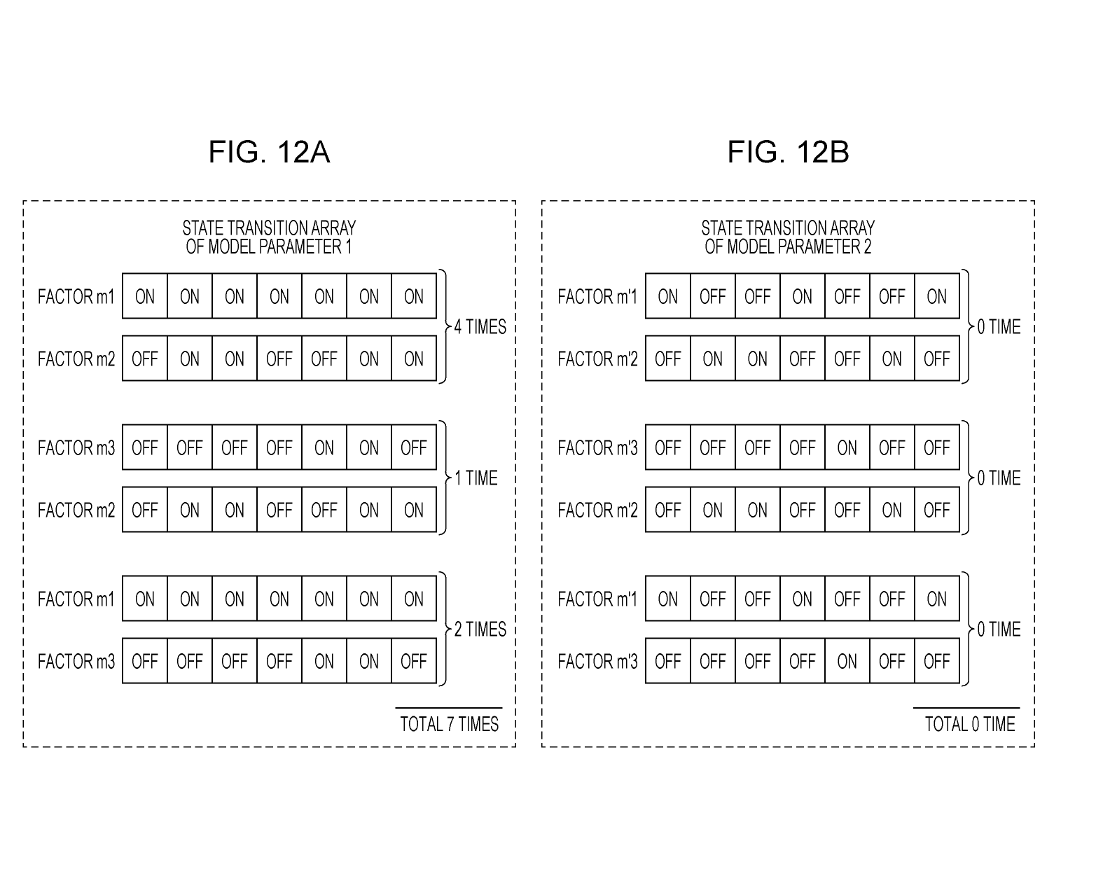

A description will next be made about one example of the process of S34 with reference to FIG. 12A and FIG. 12B.

FIG. 12A and FIG. 12B are diagrams for explaining one example of the process of S34 illustrated in FIG. 11. It is assumed that FIG. 12A illustrates a state transition array that is estimated from a model parameter 1 of the estimation results 1 illustrated in FIG. 4B, for example, by the state transition array estimation unit 123c. Further, it is assumed that FIG. 12B illustrates a state transition array that is estimated from a model parameter 2 of the estimation results 2 illustrated in FIG. 4C, for example, by the state transition array estimation unit 123c. Here, in a case where there are three electric devices, that is, the number of factors M=3, there are three combinations, in each of which two factors are combined. FIG. 12A and FIG. 12B respectively illustrate such three combinations of the state transition array.

In this case, each of two factors in the combinations is in either one of the ON and OFF states in each of the times. In S34, the parameter estimation unit 121c counts the frequency of times in which both of two factors are ON among the times. The parameter estimation unit 121c then selects the state transition array, in which the total value of the frequency of the three combinations becomes greatest and selects the model parameter that is used to estimate the selected state transition array. In the examples illustrated in FIG. 12A and FIG. 12B, the total value is seven times in the state transition array of the model parameter 1, and the total value is zero time in the state transition array of the model parameter 2. Accordingly, the parameter estimation unit 121c selects the model parameter 1 that is used to estimate the state transition array whose total value is seven times.

### [Effects]

A power use state estimation method and so forth of this embodiment may improve the accuracy of learning results of the FHMM.

More specifically, in the power use state estimation method and so forth of this embodiment, the model parameter in which the frequency of the simultaneous ON states in the state transition array is highest is decided from the two or more model parameters that are calculated by using plural random numbers in the initialization process. Accordingly, the state transition array that represents the characteristics of the power data of the electric devices that switching between ON and OFF states less frequently occurs may be estimated, and results closer to the real use states of the electric devices may thus be obtained.

As described above, the power use state estimation methods and so forth of the present disclosure may improve the accuracy of learning results of FHMM and may thus estimate one model parameter that is most suitable for estimating the real use states of the electric devices.

In the foregoing, a description has been made about the power use state estimation methods, the power use state estimation apparatuses, and programs according to one or plural aspects based on the embodiments. However, the present disclosure is not limited to the embodiments. Modes in which various kinds of modifications conceived by persons having ordinary skill in the art are applied to the embodiments and modes that are configured by combining configuration elements in different embodiments may be included in the scope of the one or plural aspects unless the modes depart from the gist of the present disclosure.

For example, in the above embodiments, the description has been made about cases where the electric devices are household electrical appliances and so forth that are used in ordinary homes and so forth. However, embodiments are not limited thereto. Electric devices may be industrial devices such as machine tools that are used in factories and so forth, for example, as long as the electric devices are connected with the panel board.

In the above embodiments, the description has been made about methods and so forth of estimating the power use states of the electric devices by accurately learning model parameters of the FHMM from the power data as the total values of the power consumption of the electric devices based on the characteristics of the power data. However, embodiments are not limited thereto. The techniques of the present disclosure provide the methods that may obtain the most realistic model parameter from plural local solutions by a method in consideration of the characteristics of time-series data in a case where an analysis is performed for time-series data by using the FHMM as a model. Thus, for example, the techniques of the present disclosure may be applied to a time-series data state estimation method that analyzes time-series data in which signals (output values) generated from plural generation resources are synthesized into one value, as well as a method that analyzes use sates of power data or the like which may be measured in a state where plural electric devices using power are connected together.

Specifically, a time-series data state estimation method includes estimating a parameter for estimating a model parameter in a case where plural latent states that provide output values are modeled by a probability model by using time-series data that are formed with totals of plural output values, in which in the estimating a parameter, a model parameter in which likelihood calculated by a likelihood function becomes a maximum is estimated based on characteristics of the time-series data which are capable of being predetermined as prior knowledge, the probability model is an FHMM, and the likelihood is a value that indicates certainty of a pattern of a total value of the plural output values which are indicated by the time-series data modeled by the FHMM with respect to a total value of the plural output values which are actually measured. A method of using the characteristics of the time-series data as the prior knowledge is the same as the above-described method, and a description thereof will thus not be made.

In the embodiments, the configuration elements may be realized by configuring those with dedicated hardware or by executing software programs that are suitable for the configuration elements. A program execution unit such as a CPU or a processor reads out and executes software programs that are recorded in a recording medium such as a hard disk or a semiconductor memory, and the configuration elements may thereby be realized. Here, software that realizes the power use state estimation methods of the above-described embodiments is the following program.

That is, a program that estimates power use states is a program that estimates power use states and that includes estimating a parameter for estimating a model parameter in a case where operating states of plural electric devices are modeled by a probability model by using total values of power consumption of the plural electric devices that are connected with a panel board, in which in the estimating a parameter, a model parameter in which likelihood calculated by a likelihood function becomes a maximum is estimated based on characteristics of power data which are capable of being predetermined as prior knowledge from an operation tendency of each of the plural electric devices, the probability model is a factorial HMM, and the likelihood is a value that indicates certainty of a pattern of a total value of the power consumption that is modeled by the factorial HMM with respect to a total value of the power consumption which is actually measured.

Further, this estimating may be performed by a program execution unit such as a CPU or a processor. Further, portions of the above estimating that are not performed by the program execution unit such as a CPU or a processor may be performed by dedicated hardware.

The techniques of the present disclosure may be applied to a power use state estimation method, a power use state estimation apparatus, and a program that estimate use states of electric devices from power data that may be measured in a state where the plural electric devices which use power are connected together.

What is claimed is:

1. A method comprising:
acquiring, using a processor, a total value of power consumption of plural electric devices that are connected with a panel board; and
estimating, using the processor, a model parameter where operating states of the plural electric devices are modeled by a probability model by using the total value,
wherein in the estimating, estimating the model parameter in which likelihood that is calculated by a likelihood function becomes a maximum is estimated using characteristics of power data that are predetermined as prior knowledge from an operation tendency of each of the plural electric devices,
the probability model is a factorial hidden Markov model, and
the likelihood is a value that indicates certainty of a pattern of a total value of the power consumption which is modeled by the factorial hidden Markov model with respect to a total value of the power consumption that is actually measured.

2. The method according to claim 1,
wherein the model parameter includes an initial probability, a state transition probability of a latent sequence, and an observation probability that is expressed by an observation average and a covariance.

3. The method according to claim 2,
wherein the likelihood function is in advance stored in a memory,
wherein in the estimating,
updating the likelihood function by incorporating the characteristics of the power data in the likelihood function; and
calculating the model parameter in which the likelihood which is calculated by the likelihood function which is updated in the updating becomes a maximum.

4. The method according to claim 3,
wherein in the calculating, calculating two or more model parameters in which the likelihood which is calculated by the likelihood function which is updated by the updating becomes a maximum by being provided with plural initial values, and
wherein in the estimating,
selecting the model parameter in which a self-transition probability is highest from the two or more model parameters which are calculated in the calculating.

5. The method according to claim 2,
wherein the characteristic of the power data is that an observation value of the power data becomes a total value of power amounts that are output from the plural electric devices,
wherein in the estimating:
calculating two or more model parameters in which the likelihood becomes a maximum by being provided with plural initial values; and
selecting the model parameter in which a total of the observation averages becomes the observation value of the power data from the two or more model parameters that are calculated by the calculating using the characteristics of the power data.

6. The method according to claim 2,
wherein the characteristic of the power data indicates a tendency in which the plural electric devices are simultaneously used, and
wherein in the estimating,
calculating two or more model parameters in which the likelihood becomes a maximum by being provided with plural initial values,
estimating a state transition array for estimating two or more state transition arrays from the two or more model parameters that are calculated in the calculating and observation data, and
selecting the model parameter that estimates the state transition array in which times in which the plural electric devices are simultaneously used are most from the two or more state transition arrays which are estimated by the estimating a state transition array based on the characteristics of the power data.

7. An apparatus comprising:
a processor; and
a memory having a computer program stored thereon, the computer program causing the processor to execute operations including:
acquiring a total value of power consumption of plural electric devices that are connected with a panel board; and
estimating a model parameter where operating states of the plural electric devices are modeled by a probability model by using the total value,
wherein the probability model is a factorial hidden Markov model, and
in the estimating, estimating the model parameter in which likelihood that is calculated by a likelihood function becomes a maximum is estimated using characteristics of power data that are predetermined as prior knowledge from an operation tendency of each of the plural electric devices, and
the likelihood is a value that indicates certainty of a pattern of a total value of the power consumption which is modeled by the factorial hidden Markov model with respect to a total value of the power consumption that is actually measured.

8. A non-transitory recording medium having a computer program stored thereon, the computer program causing a processor to execute operations comprising:
acquiring a total value of power consumption of plural electric devices that are connected with a panel board; and
estimating a model parameter where operating states of the plural electric devices are modeled by a probability model by using the total value,
wherein in the estimating, estimating the model parameter in which likelihood that is calculated by a likelihood function becomes a maximum is estimated using characteristics of power data that are predetermined as prior knowledge from an operation tendency of each of the plural electric devices,
the probability model is a factorial hidden Markov model, and
the likelihood is a value that indicates certainty of a pattern of a total value of the power consumption which is modeled by the factorial hidden Markov model with respect to a total value of the power consumption that is actually measured.
